(19) United States
(12) Patent Application Publication
(10) Pub. No.: US 2007/0047256 A1
(43) Pub. Date: Mar. 1, 2007

(54) Backlight unit, display device having the same and method of controlling a light source

(75) Inventors: Ki-bum Seong, Anyang-si (KR); Sang-hoon Lee, Ulsan-city (KR); Tae-hee Cho, Seoul (KR); Jeong-il Kang, Yongin-si (KR); Su-gun Kim, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/512,188

(22) Filed: Aug. 30, 2006

(30) Foreign Application Priority Data
Aug. 31, 2005 (KR) 2005-80764

(51) Int. Cl. F21V 7/04

(52) U.S. Cl. 362/612

(57) ABSTRACT

The present invention provides a backlight unit comprising a light source unit divided into a plurality of divisions which are driven independently each other, a light source driving group supplying electric power to the light source unit and comprising a multi-driving part which is connected to the divisions of at least two, and a light source controller controlling the light source driving group so as to selectively supply electric power to the divisions connected to the multi-driving part. The present invention also provides a method of controlling the backlight unit. Thus, the present invention provides a backlight unit and method for controlling a backlight unit comprising a light source unit which is divided into simple configurations and is efficiently driven.

### CROSS-REFERENCE TO RELATED APPLICATIONS

This application claims the benefit under 35 U.S.C. §119(a) of Korean Patent Application No. 2005-0080764, filed on Aug. 31, 2005, in the Korean Intellectual Property Office, the entire disclosure of which is hereby incorporated by reference.

### BACKGROUND OF THE INVENTION

1. Field of Invention

The present invention relates to a backlight unit, a display device having the same, and a method of providing a light source. More particularly, the present invention relates to a backlight unit, a display device having the same and method for providing a light source having a divided configuration.

2. Description of the Related Art

Recently, a flat display device, such as a liquid crystal display (LCD), a plasma display panel (PDP) and an organic light emitting diode (OLED), has been developed as a replacement for a CRT.

An LCD comprises an LCD panel having a thin film transistor (TFT) substrate, a color filter substrate and liquid crystals interposed between both substrates. The LCD panel does not emit light by itself, thus there is disposed a backlight unit in back of the TFT substrate to provide light. Transmittance of the light irradiated from the backlight unit is adjusted according to the arrangement of the liquid crystals which are in turn controlled by the TFTs. The LCD panel and the backlight unit are accommodated in a casing.

The backlight unit is either an edge type backlight unit or a direct type backlight unit according to a position of a light source.

In the edge type backlight unit, a light source is installed on a side of a light guiding plate. The edge type backlight unit is typically used with a small LCD device such as a monitor for a laptop computer or a monitor for a desktop computer. The edge type backlight unit has various advantages such as uniformity of light, long life and so on. Furthermore, the LCD may become thinner by using the edge type backlight unit.

Development of the direct type backlight unit has been strongly influenced by the development of large-screen LCDs. In the direct type backlight unit, a plurality of light sources are disposed under the LCD panel and directly emit light towards the surface of the LCD panel. The direct type backlight unit uses a greater number of light sources as compared to the edge type backlight unit. Thus, the direct type backlight unit obtains higher brightness, although the brightness is not uniform.

A point light source, such as a light emitting diode (LED), has gained notice as a direct type backlight unit. The point light source provides white light by mixing light from point light sources emitting different colors.

One driving method for a backlight unit turns on the light source in correspondence with input of a scanning signal of the LCD panel, thereby improving a moving image quality. However, this method divides the light source into a plurality of areas which are driven independently. Thus, each area requires its own driving part.

Accordingly, there is a need for an improved backlight unit, device employing the same and method for providing a light source having a divided configuration.

### SUMMARY OF THE INVENTION

Exemplary embodiments of the present invention address at least the above problems and/or disadvantages and provide at least the advantages described below. Accordingly, it is an aspect of the present invention to provide a backlight unit and method for providing a light source which is divided into simple configurations that are efficiently driven.

Another aspect of the present invention is to provide an LCD comprising a backlight unit having a light source unit which is divided into simple configurations that are efficiently driven.

The foregoing and other objects are substantially realized by providing a backlight unit comprising a light source unit divided into a plurality of divisions which are driven independently of each other, a light source driving unit supplying power to the light source unit and comprising at least one multi-driving part which is connected to at least two of the divisions, and a light source controller controlling the light source driving unit so as to selectively supply power to the divisions connected to the multi-driving part.

According to an exemplary embodiment of the present invention, the light source unit comprises a light emitting diode.

According to an exemplary embodiment of the present invention, each of the plurality of divisions has a bar shape and are disposed in parallel with each other.

According to an exemplary embodiment of the present invention, the light source controller controls the light source driving unit so as to supply power to the divisions sequentially and repeatedly.

According to an exemplary embodiment of the present invention, the times for supplying power to the adjacent divisions partially overlap.

According to an exemplary embodiment of the present invention, the divisions connected to the multi-driving part are separated from each other.

The foregoing and other objects are substantially realized by providing a backlight unit comprising a light source unit divided into a plurality of horizontal divisions which are driven independently of each other, a light source driving unit supplying power to the light source unit and comprising a fewer number of light source driving parts than the number of horizontal divisions, and a light source controller controlling the light source driving unit so as to supply power to the horizontal divisions sequentially and repeatedly.

The foregoing and other objects are substantially realized by providing a display device comprising a display panel, a light source unit disposed in back of the display panel and divided into a plurality of divisions which are driven independently of each other, a light source driving unit supplying power to the light source unit and comprising a multi-driving part which is connected to at least two of the divisions, and a light source controller controlling the light source driving unit so as to supply power to the respective divisions corresponding to image scanning of the display panel.

According to an exemplary embodiment of the present invention, the light source controller controls the light source driving group unit so as to selectively supply power to the divisions connected to the multi-driving part.

According to an exemplary embodiment of the present invention, the light source unit comprises a light emitting diode.

According to an exemplary embodiment of the present invention, each of the plurality of divisions has a bar shape and are disposed in parallel with each other.

According to an exemplary embodiment of the present invention, the light source controller controls the light source driving unit so as to supply power to the divisions sequentially and repeatedly.

According to an exemplary embodiment of the present invention, the divisions connected to the multi-driving part are separated from each other.

According to an exemplary embodiment of the present invention, the display panel comprises a liquid crystal display panel.

Other objects, advantages, and salient features of the invention will become apparent from the detailed description, which, taken in conjunction with the annexed drawings, discloses exemplary embodiments of the invention.

### BRIEF DESCRIPTION OF THE DRAWINGS

These and other aspects, features, and advantages of certain embodiments of the present invention will more apparent and more readily appreciated from the following detailed description, taken with reference to the accompanying drawings, in which:

FIG. 1 is a block diagram of an LCD according to a first exemplary embodiment of the present invention;

FIG. 2 is a sectional view of the LCD according to the first exemplary embodiment of the present invention;

FIG. 3 shows a connection between a light source unit and a light source driving unit according to the first exemplary embodiment of the present invention;

FIG. 4 shows how to drive the light source unit by horizontal divisions according to the first exemplary embodiment of the present invention;

FIG. 5 shows how to drive the light source unit by multi-driving parts according to the first exemplary embodiment of the present invention;

FIGS. 6 and 7 show a connection between a light source unit and a light source driving unit according to a second exemplary embodiment and a third exemplary embodiment of the present invention, respectively.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements thereof, are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In the following exemplary embodiment, a point light source will be described using an LED as an example. However, the invention is not limited to an LED. Other point light sources incorporated into the LCDs of the exemplary embodiment described herein are also within the scope of these embodiments and this invention. Also, a display device will be described using an LCD as an example, but the invention is not limited thereto. Other display devices comprising a backlight unit would also be within the scope of these embodiments and this invention.

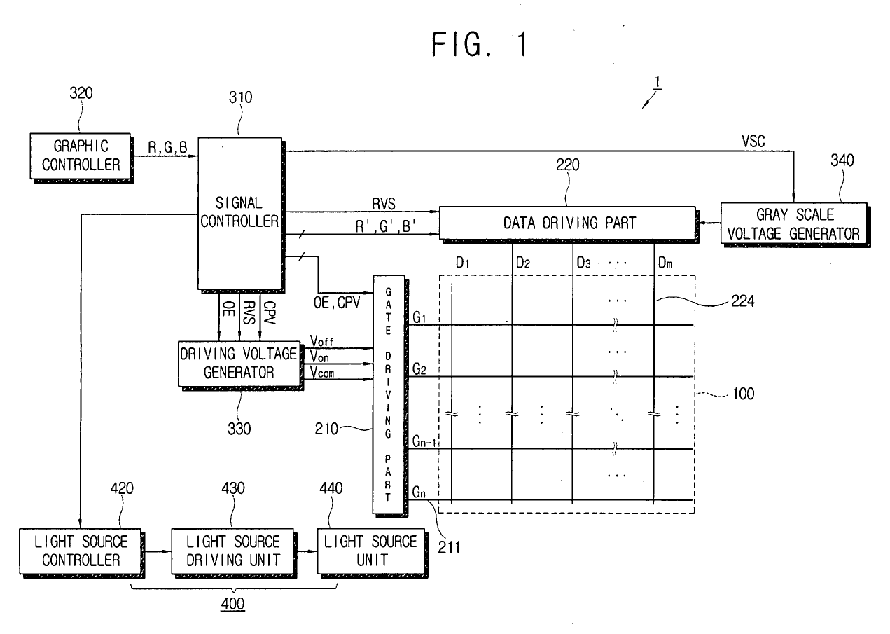

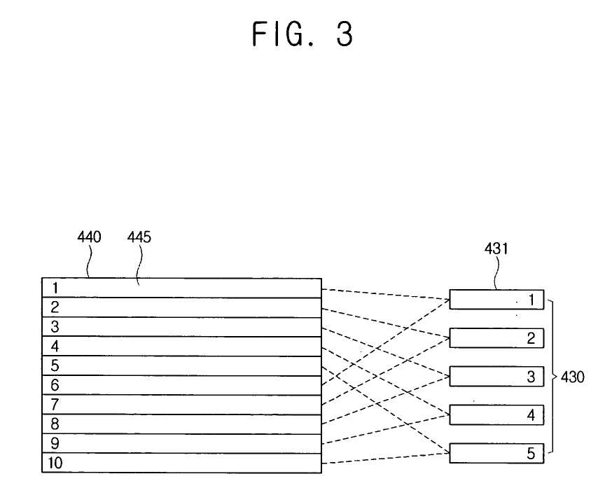

Referring to FIGS. 1 through 3, a first exemplary embodiment of the present invention will be described as follows.

An LCD 1 comprises an LCD panel 100, a gate driving part 210, a data driving part 220, a driving voltage generator 330, a gray scale voltage generator 340 and a signal controller 310. The gate driving part 210 and the data driving part 220 are connected to the LCD panel 100. The driving voltage generator 330 is connected to the gate driving part 210 and the gray scale voltage generator 340 is connected to the data driving part 220. The signal controller 310 controls the gate driving part 210, the data driving part 220, the driving voltage generator 330 and the gray scale voltage generator 340. As input, the signal controller 310 receives image data from a graphic controller 320. A backlight unit 400 is disposed in back of the LCD panel 100 to provide light. The backlight unit 400 comprises a light source unit 440, a light source driving unit 430 to drive the light source unit 440 and a light source controller 420 to control the light source driving unit 430.

The LCD panel 100 comprises a color filter substrate 111 where color filters are formed and a TFT substrate 121 where TFTs are formed. A sealant 131 is formed along the edges of both substrates 111 and 112. A liquid crystal layer 141 is disposed between both substrates 111 and 112 and the sealant 131.

The driving voltage generator 330 generates a gate-on voltage (Von) turning on the TFTs, a gate-off voltage (Voff) turning off the TFTs and a common voltage (Vcom) supplied to a common electrode.

The gray scale voltage generator 340 generates a plurality of gray scale voltages related to brightness of the LCD 1 and provides the voltage to the data driving part 220.

The gate driving part 210, called a scan driver, is connected to a gate line 211 to apply a gate signal comprising a combination of the gate-on voltage (Von) and the gate-off voltage (Voff) which are generated in the driving voltage generator 330.

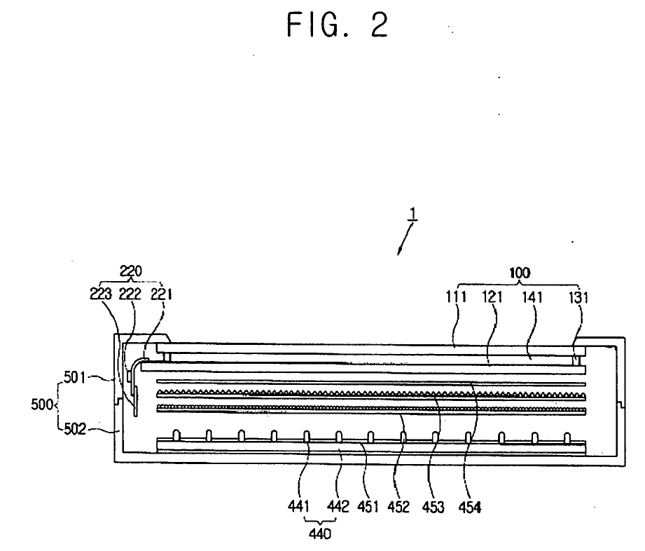

The data driving part 220, called a source driver, is applied with a gray scale voltage from the gray scale voltage generator 340 and selectively applies the gray scale voltage by each data line 224 as a data signal to the data line 224 according to control by the signal controller 310. The data driving part 220 comprises a flexible printed circuit (FPC) 221 connected to the TFT substrate 121 at one side thereof, a driving chip 222 mounted on the FPC 221 and a printed circuit board (PCB) 223 connected to another side of the FPC 221. The data driving part 220 shown in FIG. 2 is a chip on film (COF) type. However, any well-known type, such as a tape carrier package (TCP), a chip on glass (COG) or the like, may be used as the data driving part 220. The gate driving part 210 may be provided with the same type as the data driving part 220 or may be formed on the TFT substrate 121.

The signal controller 310 generates control signals controlling the gate driving part 210, the data driving part 220, the driving voltage generator 330 and the gray scale voltage generator 340 and applies them thereto.

The light source unit 440 comprises LEDs 441 and an LED circuit board 442. A plurality of LEDs 441 are mounted in the LED circuit board 442 and disposed in back of the LCD panel 100. The LEDs 441, respectively emitting red, green and blue colors, are disposed on the LED circuit board 442, thereby providing white color light to the LCD panel 100. The LEDs 441 may be arranged in various ways.

A reflecting plate 451 reflects light generated in the LEDs 441 toward the LCD panel 100. The reflecting plate 451 is disposed across the LED circuit board 442 except portions where the LEDs 441 are disposed.

A diffusion film 452 comprises a base plate and a coating layer having beads formed on the base plate. If the light from the LEDs 441 is provided directly to the LCD panel 100, an arrangement of the LEDs 441 may be such that brightness may not be uniform. In order to prevent this non-uniformity, the diffusion film 452 diffuses the light evenly so as to be evenly provided to the LCD panel 100. A prism film 453 comprises triangular prisms formed in an arrangement thereon. The prism film 453 collects the light diffused from the diffusion film 452 perpendicularly to a surface of the LCD panel 100. Typically, two prism films 453 are used and micro prisms formed on each of the prism films 453 make an angle with each other. The light passing through- the prism film 453 mostly continues perpendicularly, thereby forming a uniform brightness distribution. A protection film 454 disposed at the top of the films protects the prism film 453, which is vulnerable to scratching.

A casing 500 comprises an upper casing 501 and a lower casing 502 and accommodates the LCD panel 100 and the LEDs 441.

Hereinafter, an operation of the LCD 1 will be described in detail.

The signal controller 310 receives RGB image data (R, G, B) and an input control signal (not shown) controlling the same from the graphic controller 320. The input control signal may be a vertical synchronizing signal (Vsync), a horizontal synchronizing signal (Hsync), a main clock (CLK), a data enable signal (DE) and the like. The signal controller 310 generates a gate control signal (not shown), a data control signal (not shown) and a voltage selection control signal (VSC) based on the input control signal and converts the image data (R, G, B) to be suitable for an operation of the LCD panel 100. Then, the signal controller 310 applies the gate control signal to the gate driving part 210 and the driving voltage generator 330, applies the data control signal and the converted image data (R′, G′, B′) to the data driving part 220, and applies the voltage selection control signal (VSC) to the gray scale voltage generator 340.

The gate control signal (not shown) comprises a vertical synchronization start signal (STV, not shown) indicating a start to output a gate on pulse (gate signal in a high range), a gate clock signal (CPV) controlling output time of the gate on pulse, a gate on enable signal (OE) defining the width of the gate on pulse and the like. Of these signals, the gate on enable signal (OE) and the gate clock signal (CPV) are applied to the driving voltage generator 330 and the gate driving part 210. The data control signal comprises a horizontal synchronization start signal (STH, not shown) indicating a start to input a gray scale signal, a load signal (LOAD or TP, not shown) applying a data voltage to the data line, a reverse control signal (RVS) reversing polarity of the data voltage, a data clock signal (HCLK, not shown) and the like.

The gray scale voltage generator 340 supplies the gray scale voltage, having a voltage value corresponding to the voltage selection control signal (VSC), to the data driving part 220.

The gate driving part 210 supplies the gate-on voltage (Von) to a gate line 211 in accordance with the gate control signal from the signal controller 310, thereby turning on the TFTs which are connected to the gate line 211. At the same time, the data driving part 220, according to the data control signal from the signal controller 310, supplies the corresponding data line 224 an analog data voltage from the gray scale voltage generator 340. The analog data voltage is a data signal corresponding to the image data (R′, G′, B′). The data signal, and thus image data, is supplied to a pixel comprising a switching element which is turned on by the gate-on voltage.

The data signal applied to the data line 224 is applied to a corresponding pixel through a turned-on TFT. With this method, the gate-on voltage (Von) is applied to the gate lines 211 in order during one frame, thereby applying the data signal to every pixel. When the reverse control signal (RVS) is applied to the driving voltage generator 330 and the data driving part 220 after one frame is finished, polarities of all the data signals in a next frame are changed.

An exemplary method of driving the light source unit 440 while the LCD panel 100 forms a picture will now be described.

The light source unit 440 is divided into a plurality of horizontal divisions 445 (for example, divisions 1-10) which are driven independently of each other. The horizontal divisions 445 each have substantially the same area, a bar shape and are disposed in parallel with each other. The horizontal divisions 445 are also disposed in parallel with the gate line 211.

The light source driving unit 430 supplying electric power to the light source unit 440 comprises a plurality of multi-driving parts 431. The number of the multi-driving parts 431 is less than the number of the horizontal divisions 445. For example, there are ten horizontal divisions 445 and five multi-driving parts 431 the first exemplary embodiment.

Each of the multi-driving parts 431 is connected to two horizontal divisions 445 to supply power. A pair of horizontal divisions 445 which are connected to the same multi-driving part 431 are separated from each other. For example, the first multi-driving part 431 is connected to the first horizontal division 445 and the sixth horizontal division 445 which are separated from each other by the second through fifth horizontal divisions.

The light source controller 420 is connected to the signal controller 310 to control the light source driving unit 430 so that the respective horizontal divisions 445 are driven corresponding to scanning of an LCD panel 100. Accordingly, the horizontal divisions 445 are sequentially and repeatedly driven.

Also, the light source controller 420 controls the light source driving unit 430 so that the pair of horizontal divisions 445 connected to the same multi-driving part 431 are driven at regular intervals. Accordingly, the pair of horizontal divisions 445 may be driven by the same multi-driving part 431 without interfering with each other, thereby simplifying a configuration of the light source driving unit 430.

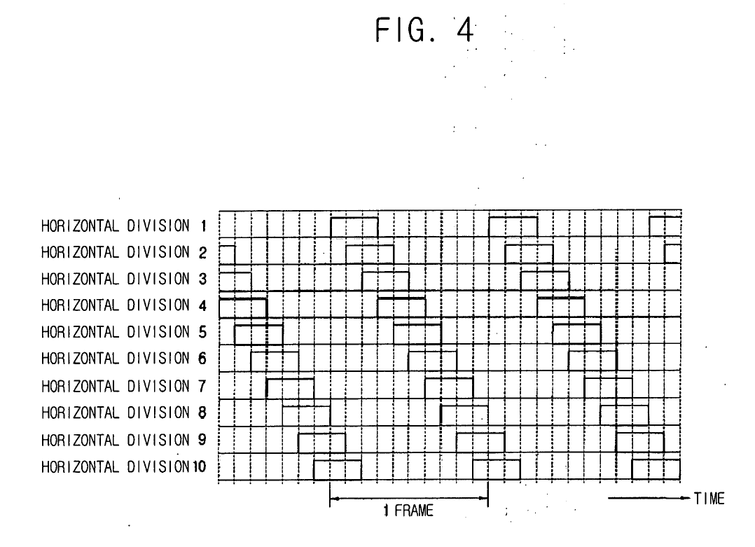

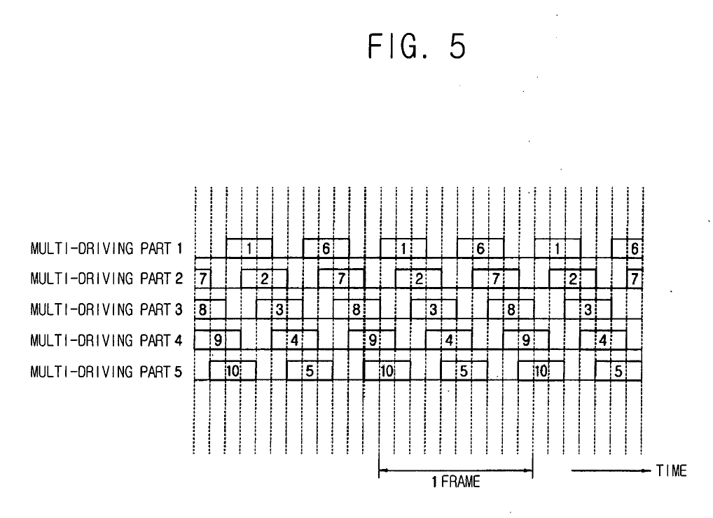

An exemplary method of driving a light source unit 440 will now be described with reference to FIGS. 4 and 5.

FIG. 4 shows a method of driving the light source unit with reference to the horizontal divisions according to the first exemplary embodiment of the present invention and FIG. 5 shows a method of driving the light source unit with reference to the multi-driving parts according to the first exemplary embodiment of the present invention.

As shown in FIG. 4, an exemplary image frame (1 FRAME) is divided into ten periods as indicated by the vertical grid lines. Each of the horizontal divisions 445 (in other words, HORIZONTAL DIVISIONs 1-10) is driven for three periods in each frame. Furthermore, each of the horizontal divisions 445 is driven such that, at any given period within a frame, three different horizontal divisions are being driven. Also, a following horizontal division 445 (for example, horizontal division 3) starts to be driven one period after a previous horizontal division 445 (for example, horizontal division 2) is driven. As such, two consecutive horizontal divisions 445 (for example horizontal divisions 2 and 3) are each driven for three consecutive periods but are driven at the same time for only two periods. Likewise, ten horizontal divisions 445 are driven for one frame.

A point when the first horizontal division 445 is driven is substantially the same as a point when the first gate line 211 is applied with the gate-on voltage.

As shown in FIG. 5, the sixth horizontal division 445 is driven two periods after the first horizontal division 445 has been driven for three periods, wherein the first horizontal division 445 and the sixth horizontal division 445 are connected to the first multi-driving part 431. Likewise, the first horizontal division 445 is re-driven two periods after the sixth horizontal division 445 has been driven for three periods. Thus, the pair of horizontal divisions 445 may be driven by the same multi-driving part 431 without interfering with each other.

Therefore, according to the first exemplary embodiment, a number of multi-driving parts 431 less than the number of horizontal divisions 445 may be used to drive the light source unit 440.

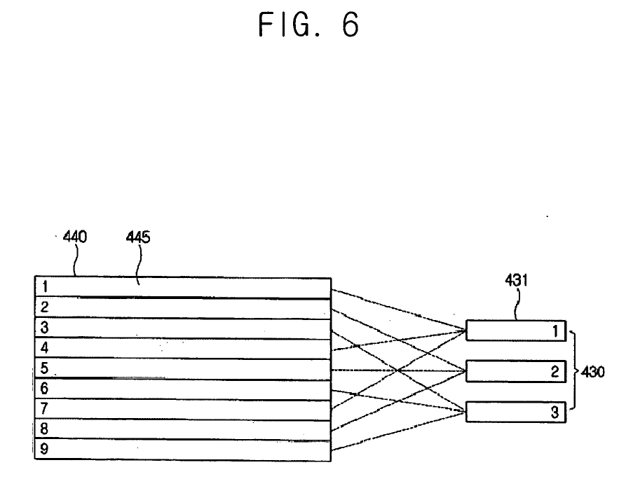

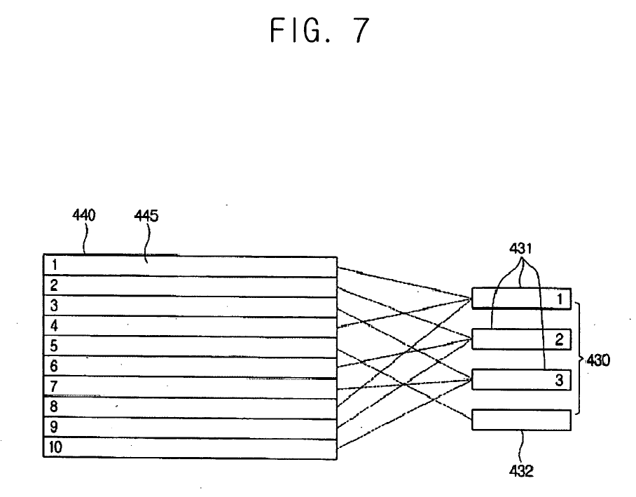

FIGS. 6 and 7 show a connection between a light source unit and a light source driving unit according to a second exemplary embodiment and a third exemplary embodiment of the present invention, respectively.

According to the second exemplary embodiment shown in FIG. 6, there are provided nine horizontal divisions 445 and three multi-driving parts. Each of the multi-driving parts 431 is connected to three horizontal divisions 445. The horizontal divisions 445 connected to the same multi-driving part 431 are separated from one another.

The number of the horizontal divisions 445 connected to a single multi-driving part 431 may vary according to the number of divisions of a light source unit 440, driving time of a single horizontal division 445 and the like.

According to the third exemplary embodiment shown in FIG. 7, there are provided ten horizontal divisions 445. A light source driving unit 430 comprises three multi-driving parts 431 and one single-driving part 432. Each of the multi-driving parts 431 is connected to three horizontal divisions 445. The horizontal divisions 445 connected to the same multi-driving part 431 are separated from one another.

The light source driving unit 430 may comprise both the multi-driving parts 431 and the single-driving part 432 depending on the number of the horizontal divisions 445. Also, the light source driving unit 430 may comprise multi-driving parts 431 connected to the different number of horizontal divisions.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A backlight unit, comprising:
a light source unit comprising a plurality of divisions;
a light source driving unit comprising at least one multi-driving part which is connected to at least two divisions; and
a light source controller for controlling the light source driving unit to selectively supply the power to the divisions.

2. The backlight unit of claim 1, wherein the light source unit comprises a light emitting diode.

3. The backlight unit of claim 1, wherein each of the divisions has a bar shape and the divisions are disposed in parallel with each other.

4. The backlight unit of claim 3, wherein the light source controller controls the light source driving unit so as to supply power to the divisions sequentially and repeatedly.

5. The backlight unit of claim 4, wherein the sequentially supplied power is supplied to adjacent divisions at least during overlapping time periods.

6. The backlight unit of claim 3, wherein the at least two divisions connected to the multi-driving part are separated from each other.

7. A backlight unit, comprising:
a light source unit comprising a plurality of horizontal divisions;
a light source driving unit comprising at least one light source driving part and supplying power to the light source unit wherein the number of light source driving parts is less than the number of horizontal divisions; and
a light source controller controlling the light source driving unit so as to supply power to the horizontal divisions sequentially and repeatedly.

8. A display device, comprising:
a display panel;
a light source unit disposed in back of the display panel and comprising a plurality of divisions;
a light source driving unit supplying power to the light source unit and comprising at least one multi-driving part which is connected to at least two divisions; and
a light source controller for controlling the light source driving unit so as to supply power to divisions corresponding to image scanning of the display panel.

9. The display device of claim 8, wherein the light source controller controls the light source driving unit so as to selectively supply power to the divisions connected to the multi-driving part.

10. The display device of claim 8, wherein the light source unit comprises a light emitting diode.

11. The display device of claim 8, wherein each of the plurality of divisions has a bar shape and the divisions are disposed in parallel with each other.

12. The display device of claim 11, wherein the light source controller controls the light source driving unit so as to supply power to the divisions sequentially and repeatedly.

13. The display device of claim 11, wherein the at least two divisions connected to the multi-driving part are separated from each other.

14. The display device of claim 8, wherein the display panel comprises a liquid crystal display panel.

15. A method of controlling a light source, comprising:
providing power to a first division of the light source starting at a first time and for a first duration;
providing power to a second division of the light source starting at a second time and for a second duration;
wherein the first time is different than the second time, the first duration is substantially the same as the second duration, and the first and second durations partially overlap.

16. The method of claim 15, wherein the power provided to the first division is from a first multi-driving part and the power provided to the second division is from a second multi-driving part.

17. The method of claim 16, wherein the first division is separate from the second division.

18. The method of claim 16, further comprising:
providing power to a third division of the light source from the first multi-driving part; and
providing power to a fourth division of the light source from the second multi-driving part.

19. The method of claim 18, wherein the first multi-driving part supplies power to the first and third divisions of the light source at separate times and the second multi-driving part supplies power to the second and fourth divisions of the light source at separate times.

20. The method of claim 19, further comprising supplying power to the first, second, third and fourth divisions of the light source sequentially and repeatedly.

21. A method of controlling a light source, comprising:
providing power to at least a first two of a plurality of divisions of the light source by a first multi-driving part, the power being provided to the at least first two divisions at separate times;
providing power to at least a second two of the plurality of divisions of the light source by a second multi-driving part, the power being provided to the at least second two divisions at separate times;
wherein the first two divisions of the light source are separated from each other and the second two divisions of the light source are separated from each other.
